(19) United States
(12) Patent Application Publication
(10) Pub. No.: US 2011/0157091 A1
(43) Pub. Date: Jun. 30, 2011

(54) TOUCH-ENABLED DISPLAY DEVICE

(75) Inventor: JEN-TSORNG CHANG, Tu-Cheng (TW)

(73) Assignee: HON HAI PRECISION INDUSTRY CO., LTD., Tu-Cheng (TW)

(21) Appl. No.: 12/855,859

(22) Filed: Aug. 13, 2010

(30) Foreign Application Priority Data
Dec. 29, 2009 (CN) 200910312519.2

(51) Int. Cl. G06F 3/042; G06F 3/041

(52) U.S. Cl. 345/175; 345/173

(57) ABSTRACT

A touch-enabled display device includes a display surface, two light emitting members and two linear image sensing devices. The display surface includes a first corner, a second corner, a third corner, a fourth corner, a first diagonal connecting the first corner and the second corner, and a second diagonal connecting the third corner and the fourth corner. The two light emitting members are respectively disposed near the first corner and the third corner The two linear image sensing devices are disposed near the second corner and the fourth corner. Each linear image device is aligned with one of the two light emitting members and long a diagonal. Each linear image sensing device is capable of detecting an image of a contact location that is parallel to the diagonal.

### BACKGROUND

1. Technical Field

The present disclosure relates to display technology, and particularly, to a touch-enabled display device.

2. Description of the Related Art

Touch-enabled displays provide convenient input and have thus gained considerable popularity. At present, infrared, resistive, capacitive, and sound wave touch-enabled display devices are commonly used.

A touch-enabled display device includes a display surface, a plurality of infrared light emitting members and a plurality of infrared sensors. The display surface includes two pairs of opposite sides parallel to each other. The infrared light emitting members are disposed on two adjacent sides, and are spaced evenly from each other. The infrared sensors are disposed on the other two adjacent sides, and are spaced evenly from each other. Each infrared sensor is disposed corresponding to one infrared light emitting member, such that connections between the infrared sensors and the infrared light emitting members constitute a rectangular grid. The two adjacent sides of the display surface represent X axis and Y axis respectively. Upon contact with the display surface, light from two infrared light emitting devices respectively disposed on the X axis and the Y axis is blocked by the contact location, and corresponding infrared sensors cannot detect the light from the two infrared light emitting devices. Ranked numbers of the two infrared light emitting devices represent the position of the contact location in the X and Y coordinates. However, the touch-enabled display device requires a considerable population of infrared light emitting devices and infrared sensors, such that the touch-enabled display device incurs high cost and complicated structure.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a schematic view of one embodiment of a touch-enabled display device including two optical members and two linear image sensing devices.

FIG. 2 is an assembled, isometric view of one optical member disposed in the corresponding linear image sensing device shown in FIG. 1.

FIG. 3 is a cross-section taken along line of FIG. 2.

FIG. 4 is a cross-section taken along line IV-IV of FIG. 2.

FIG. 5 is a cross-section taken along line V-V of FIG. 2.

FIG. 6 is a cross-section taken along line VI-VI of FIG. 2.

FIG. 7 is a schematic view of projection coordinates in the X axis of a contact location shown in FIG. 1.

FIG. 8 is a schematic view of projection coordinates in the Y axis of a contact location shown in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

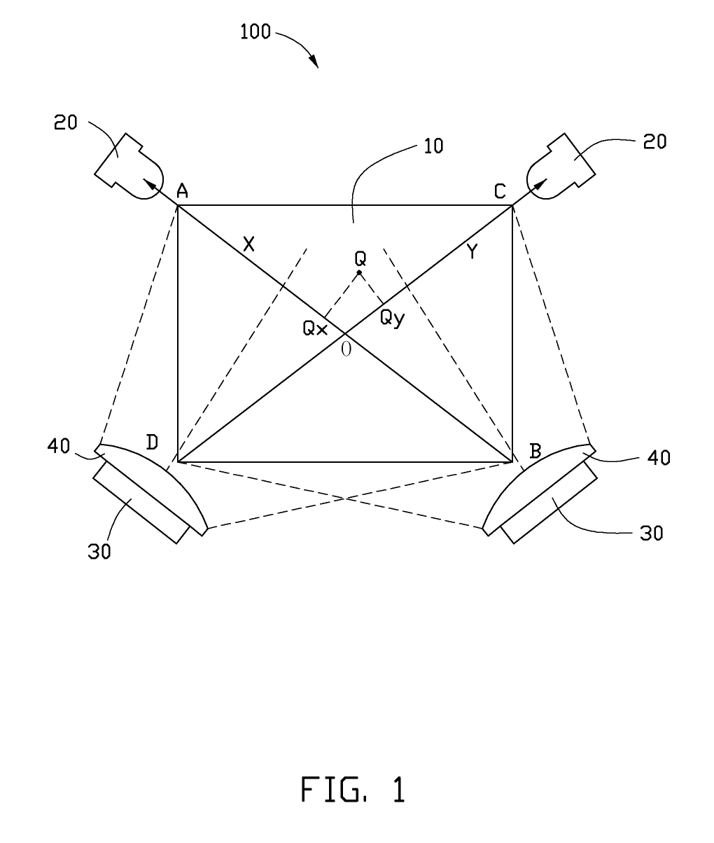

Referring to FIG. 1, one embodiment of a touch-enabled display device 100 includes a display surface 10, two light emitting members 20, two linear image sensing devices 30 and two optical members 40. The two light emitting members 20 are disposed near two corners of the display surface 10. The two linear image sensing devices 30 are disposed near the other two corners of the display surface 10. Each light emitting member 20 is one linear image sensing device 30. Each linear image sensing device 30 is aligned with one light emitting member 20, and parallel to the other diagonal of the display surface 10. The two optical members 40 are disposed on the two linear image sensing devices 30, such that light emitted from the light emitting members 20 is focused by the corresponding optical member 40, and then detected by the corresponding image sensing devices 30.

The display surface 10 is substantially rectangular includes a first corner A, a second corner B, a third corner C, a fourth corner D, a first diagonal AB, and a second diagonal CD. The first diagonal AB connects the first corner A and the second corner B. The second diagonal CD connects the third corner C and the fourth corner D. O represents an intersection of the two diagonals of the display surface 10. The two diagonals AB, CD are regarded as X axis and Y axis, and constitute a Cartesian coordinate system or an oblique coordinate system. If the diagonal AB is perpendicular to the diagonal CD, the two diagonals AB, CD constitute a Cartesian coordinate system. Otherwise, the two diagonals AB, CD constitute an oblique coordinate system. In the illustrated embodiment, the two diagonals AB, CD constitute an oblique coordinate system XOY.

The two light emitting members 20 are light-emitting diodes or light bulbs. In the illustrated embodiment, the two light emitting members 20 are infrared light-emitting diodes. Wavelengths of light emitted from the two light emitting members 20 are different, such that the two light emitting members 20 do not interfere with each other, and improve a detection accuracy of the linear image sensing devices 30.

Each linear image sensing device 30 is used to detect one-dimensional image, and includes a light detecting member array (not shown). The two linear image sensing devices 30 are CMOS (Complementary Metal-Oxide-Semiconductor) linear sensors or CCD (Charge-coupled Device) linear sensors. In one embodiment, the two linear image sensing devices 30 are CMOS linear sensors which can detect infrared. The number of light accepting members of the linear image sensing devices 30 is L. When the linear image sensing devices 30 capture an image of the diagonal AB or the diagonal CD, the number of pixels of the image is just L. That is, a length of the image of the diagonal AB or the diagonal CD equals that of L pixels.

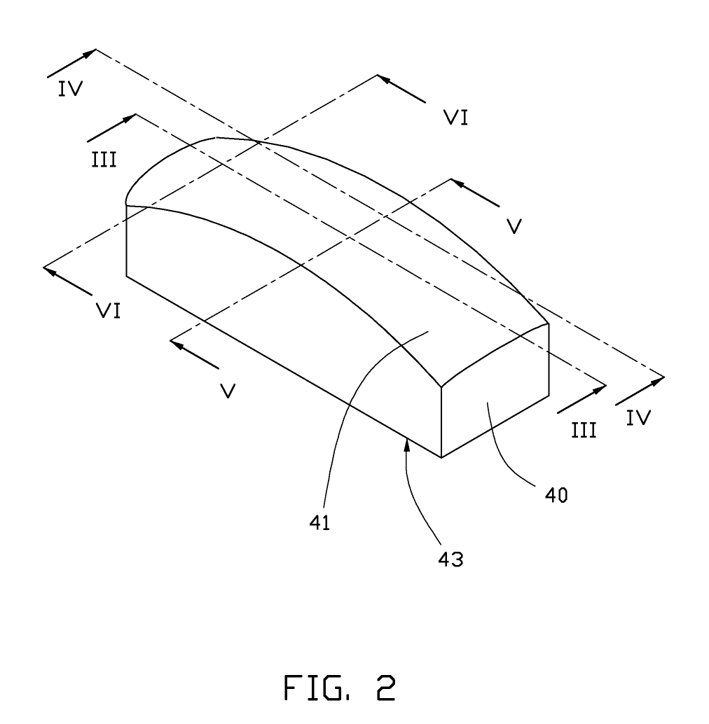

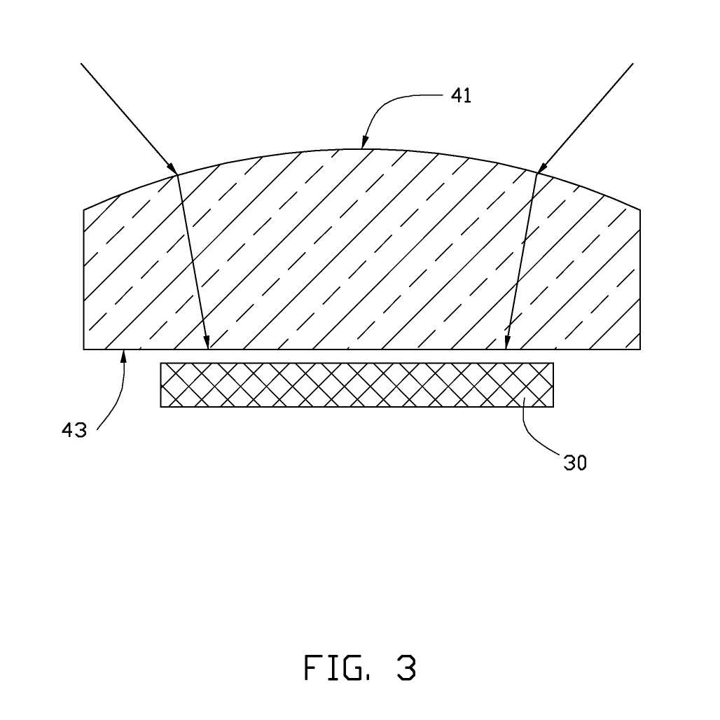

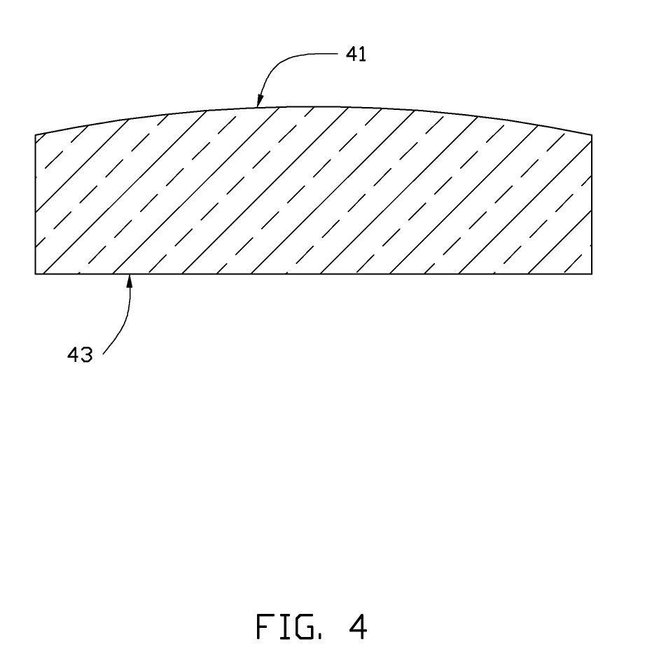

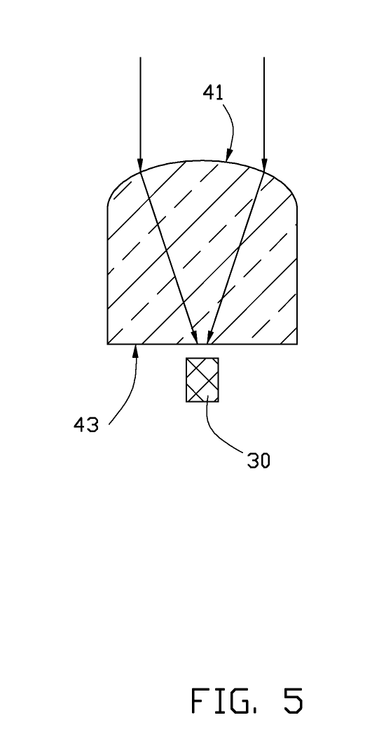

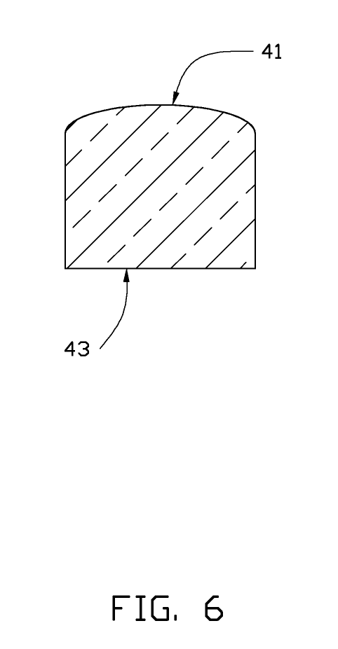

Referring to FIGS. 2 through 6, the two optical members 40 are used to increase perspective of the linear image sensing device 30. Each optical member 40 is substantially cuboid, includes a light incident surface 41 and a light-emitting surface 43 opposite to the light incident surface 41. The light incident surface 41 is substantially arcuate, and is defined on the top of each optical member 40. From the center to the sides, curvature along a longitudinal axis of the light incident surface 41 is decreased. From the center to sides, a curvature along a transverse axis of the light incident surface 41 is also decreased. The light-emitting surface 43 is substantially planar and defined on the bottom of each optical member 40. The two linear image sensing devices 30 are placed along the length of the corresponding optical members 40.

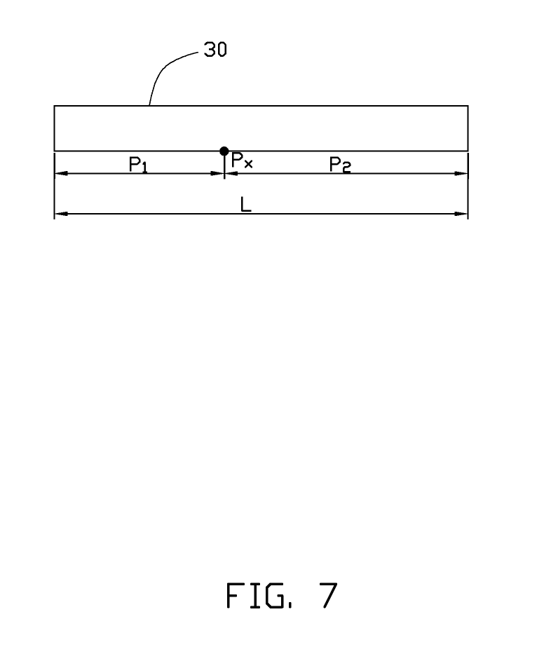

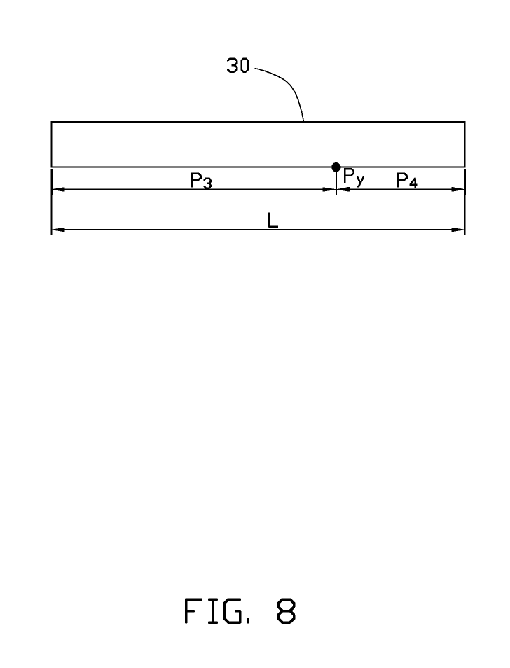

Referring to FIGS. 1, 7 and 8, a contact location Q occurs on display surface 10. Qₓ represents a vertical projection of the contact location in the X axis. Q_{y} represents a vertical projection of the contact location Q in the Y axis. (Qₓ, Q_{y}) represents a position of the contact location Q in the oblique coordinate system XOY. Pₓ represents a position of the contact location Q in the linear image sensing device 30 parallel to the X axis. The number of the pixels beside the point Pₓ are P1 and P2. This to say, a length of a line AQₓ equal to P1 pixels, a length of a line QₓB equals P2 pixels. P_{y} represents a position of the contact location in the linear image sensing devices 30 parallel to the Y axis. The number of the pixels beside the point P_{y} are P3 and P4. In other words, a length of a line DQₓ equals P3 pixels, a length of a line QₓC equals P4 pixels. The vertical projection of the contact location Q is proportional to the image of the contact location Q in the linear image sensing devices 30, as:

$$\begin{matrix}\frac{{P}_{1}}{{P}_{2}} = \frac{\vert {AQ}_{x} \vert}{\vert {Q}_{x} B \vert} & ( 1 ) \\ \frac{{P}_{3}}{{P}_{4}} = \frac{\vert {DQ}_{y} \vert}{\vert {Q}_{y} C \vert} & ( 2 )\end{matrix}$$

A geometric relationship between Qₓ, Q_{y}, Pₓ and P_{y} as:

|AB|=|AQₓ|+|QₓB| (3)

|CD|=|DQ_{y}|+|Q_{y}C| (4)

L=P₁+P₂+2d=P₃+P₄+2d (5)

wherein d is an error of the linear image sensing devices 30, and is a constant. According to formulae (1) through (5), the position of the contact location Q is determined by:

$$\begin{matrix}\frac{{P}_{1}}{L - 2 d - {P}_{1}} = \frac{\vert {AQ}_{x} \vert}{\vert AB \vert - \vert {AQ}_{x} \vert} & ( 6 ) \\ \frac{{P}_{3}}{L - 2 d - {P}_{3}} = \frac{\vert {DQ}_{y} \vert}{\vert CD \vert - \vert {DQ}_{y} \vert} & ( 7 )\end{matrix}$$

wherein |AB|, |CD| and L are measurement constant. Based on formulae (6) and (7), |AQₓ| and |DQ_{y}| are determined by |AB|, |CD| and L, such that the position of the contact location Q in the oblique coordinate system XOY is obtained.

The number of the light emitting members 20 and the linear image sensing device 30 are small. Therefore, the touch-enabled display device 100 is relatively inexpensive and has simple structure.

It is to be understood that the touch-enabled display device 100 can also be used for multi-touch applications. Length of the image of the diagonals AB and CD can be also less than L pixels. The optical element 40 can also be omitted. The wavelength of light emitted from the two light emitting devices 20 can also be the same as the wavelength of light. Meanwhile, in order to avoid the light emitted from the two light emitting devices 20 generating interference, the two light emitting devices 20 emit light at regular intervals.

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What claimed is:

1. A touch-enabled display device comprising:
a display surface comprising two diagonals;
two light emitting members; and
two linear image sensing devices, wherein each linear sensing device is aligned with one of the two light emitting members along one of the two diagonals, and each linear image sensing device is capable of detecting an image of a contact location that is parallel to the diagonal.

2. The touch-enabled display device of claim 1, wherein two diagonals define an oblique coordinate system.

3. The touch-enabled display device of claim 1, wherein each light emitting member is light-emitting diodes or light bulbs.

4. The touch-enabled display device of claim 3, wherein each light emitting member is infrared light-emitting diodes.

5. The touch-enabled display device of claim 3, wherein wavelengths of light emitted from the two light emitting members are different.

6. The touch-enabled display device of claim 1, wherein the two linear image sensing devices are CMOS linear sensors or CCD linear sensors.

7. The touch-enabled display device of claim 1, further comprising two optical members disposed on the two linear image sensing devices.

8. The touch-enabled display device of claim 7, wherein each optical member is substantially cuboid, comprising a light incident surface and a light-emitting surface opposite to the light incident surface.

9. The touch-enabled display device of claim 8, wherein the light incident surface is substantially arcuate.

10. The touch-enabled display device of claim 9, wherein a curvature along a longitudinal axis of the light incident surface is decreased from the center to sides.

11. The touch-enabled display device of claim 9, wherein a curvature along a transverse axis of the light incident surface is decreased from the center to sides.

12. A touch-enabled display device comprising:
a substantially rectangular display surface comprising a first corner, a second corner, a third corner, a fourth corner, a first diagonal defined by the first corner and the second corner, and a second diagonal defined by the third corner and the fourth corner;
two light emitting members, and each light emitting member is disposed adjacent to each the first corner and the third corner; and
two linear image sensing devices, and each linear image sensing device is disposed adjacent to each the second corner and the fourth corner and is capable of detecting an image of a contact location that is parallel to its corresponding diagonal.

13. The touch-enabled display device of claim 12, wherein the first and second diagonals define an oblique coordinate system.

14. The touch-enabled display device of claim 12, wherein each light emitting member is light-emitting diodes or light bulb.

15. The touch-enabled display device of claim 14, wherein each light emitting member is infrared light-emitting diode.

16. The touch-enabled display device of claim 14, wherein wavelengths of light emitted from the two light emitting members are different.

17. The touch-enabled display device of claim 12, wherein the two linear image sensing devices are CMOS linear sensors or CCD linear sensors.

18. The touch-enabled display device of claim 12, further comprising two optical members disposed on the two linear image sensing devices.

19. The touch-enabled display device of claim 18, wherein each optical member is substantially cuboid, comprising a light incident surface and a light-emitting surface opposite to the light incident surface.

20. The touch-enabled display device of claim 19, wherein the light incident surface is substantially arcuate.
